(19) United States
(12) Patent Application Publication
(10) Pub. No.: US 2016/0145865 A1
(43) Pub. Date: May 26, 2016

(54) PROTECTIVE PANEL

(71) Applicant: Foster-Miller, Inc., Waltham, MA (US)

(72) Inventors: Justin Trent Shackelford, Dunstable, MA (US); James A. Carter, Bedford, MA (US); Robert G. Holmes, JR., Berlin, MA (US); Scott Paul Quigley, Franklin, MA (US)

(73) Assignee: Foster-Miller, Inc.

(21) Appl. No.: 14/950,907

(22) Filed: Nov. 24, 2015

Related U.S. Application Data
(60) Provisional application No. 62/084,719, filed on Nov. 26, 2014.

(51) Int. Cl. E04B 2/00; E04C 2/28; E04H 9/04; F41H 5/02; B32B 5/18; B32B 3/14; B32B 3/06; F41H 5/04; E04B 1/92; B32B 5/24

(52) U.S. Cl. CPC E04C 2/44; E04B 1/92; E04C 2/28; E04H 9/04; B32B 5/245; B32B 5/18; B32B 3/14; B32B 3/06; F41H 5/0428; F41H 5/023; B32B 2250/02; B32B 2307/72; B32B 2307/546; B32B 2571/02

(57) ABSTRACT

A protective panel and methods are disclosed wherein the panel includes a ballistic rear face and hard points in an arrangement at or proximate a front face. A foam core retains the arrangement of hard points and spaces the hard points from the ballistic rear face.

### RELATED APPLICATIONS

This application claims benefit of and priority to U.S. Provisional Application Ser. No. 62/084,719 filed Nov. 26, 2014, under 35 U.S.C. §§119, 120, 363, 365, and 37 C.F.R. §1.55 and §1.78, which is incorporated herein by this reference.

### FIELD OF THE INVENTION

The invention relates to armor and protective panels used in a system to protect a building or other structure from rocket propelled grenades and other munitions.

### BACKGROUND OF THE INVENTION

Embassies, safe houses, government buildings, and other structures can be subject to terrorist attacks and may be outfitted with barriers and the like which may draw attention to the building.

Attempts have been made to construct the structure or building itself using armor panels. U.S. Pat. No. 8,062,741 for example, discloses building panels with a cementious core. This patent is hereby incorporated herein by this reference.

There exists, however, a need to protect existing structures and buildings not made of armor panels. Published application No. U.S. 2010/0326336 discloses examples regarding the efforts and the design of armor panels added to an existing structure in order to address numerous types of threats. See also Published Application No. 2009/0031889. Both of these references are hereby incorporated herein by this reference.

### BRIEF SUMMARY OF THE INVENTION

Needed is an armor panel system that can be easily attached to existing structures and buildings and which addresses numerous threats including bullets and rocket propelled grenades. Preferably, the panels should not call attention to the structure or building. The panels may be applied to the building using standard construction techniques. It is beneficial that the panels are easy to make and low in cost.

Featured is a protective panel comprising a ballistic rear face, hard points in an array at or proximate a front panel face, and a foam core retaining the arrangement of hard points and spacing the hard points from the ballistic rear face.

In one example, there is a protective coating on the front foam face. There may be a foam layer between the hard points and the protective coating. The ballistic rear face may include Kevlar or ceramic plates. Preferably, the foam core may include a low density brittle foam material. The foam core may be between 4-10″ thick. The panel may include an interlock feature such as a recess in the sides, top, and bottom portions of the panel.

Also featured is a method of manufacturing a protective panel. The method may include placing a structure holding an arrangement of hard points into a mold, spraying foam into the mold, and covering the mold with ballistic material. The method may further include the step of spraying the mold with a protective coating prior to placing the structure with the hard point arrangement therein.

Also featured is a method of protecting a building or structure. The method includes attaching to the building or structure a series of panels. Each panel includes hard points in a foam material spaced from a ballistic material.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic three dimensional side view of an example of a panel in accordance with the invention;

FIG. 2A is a schematic side cross sectional of the panel of FIG. 1;

FIG. 2B is a schematic side cross sectional view of another panel design;

FIG. 3 is a schematic front view showing a system of panels as depicted in FIGS. 1-2;

FIG. 4 is a schematic view showing two panels interlocked via a tongue member in accordance with an example the invention;

FIG. 5 is a schematic three dimensional front view of an example of a panel mold in accordance with the invention; and

FIG. 6 is a flow chart depicting the primary steps associated with an exemplary method of manufacturing a panel in accordance with examples of the invention.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

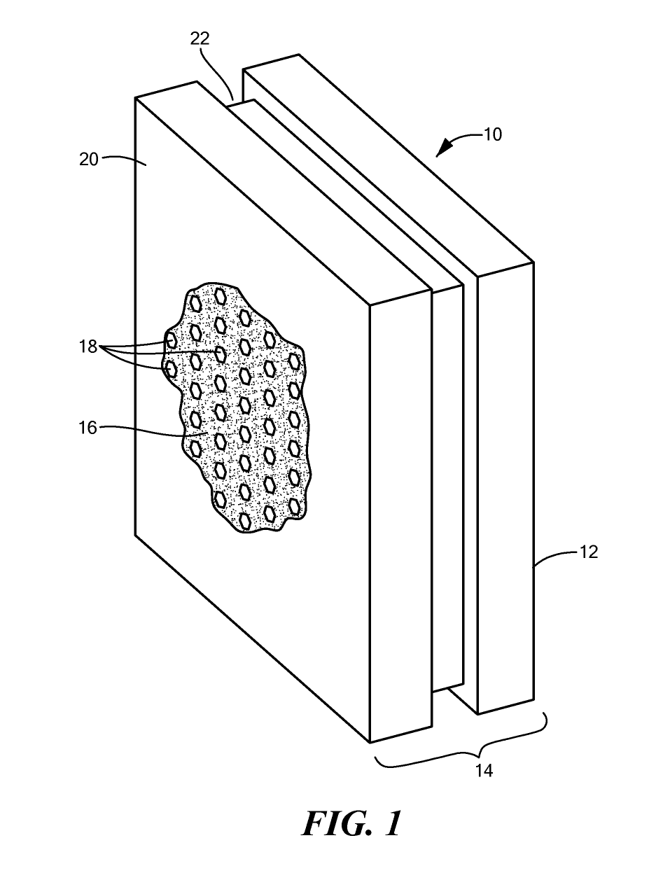

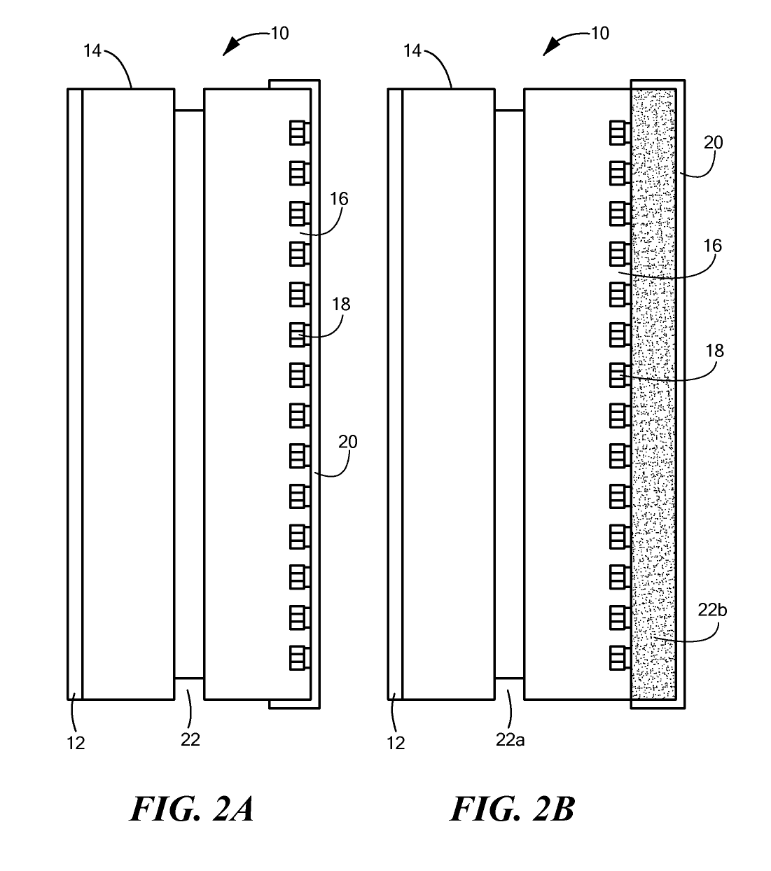

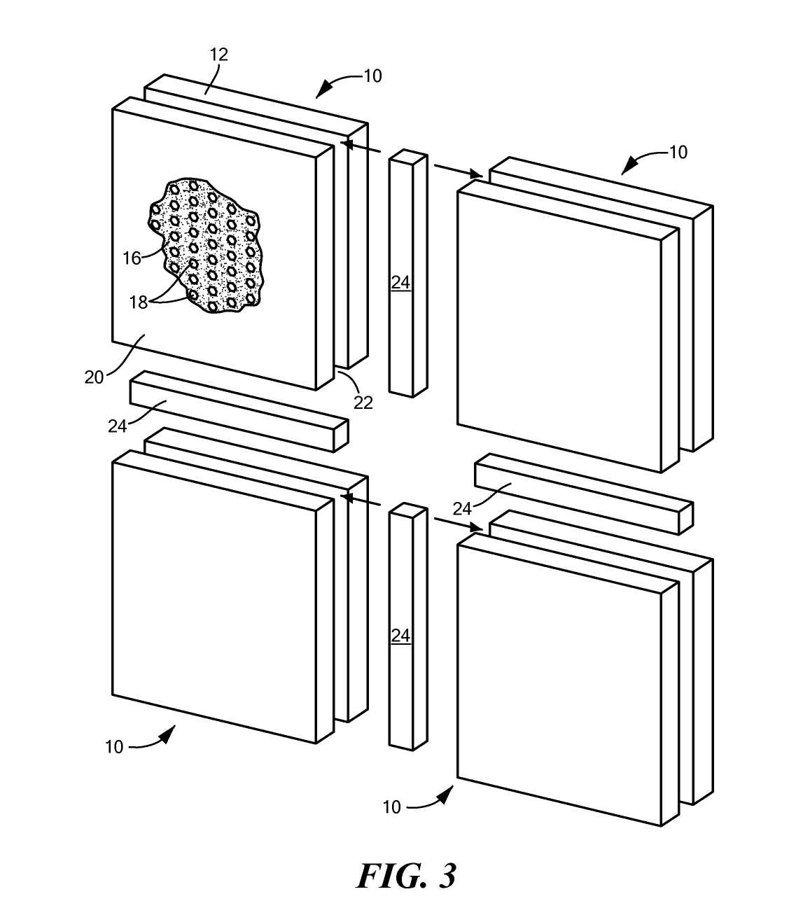

FIGS. 1 and 2 show an embodiment of an individual 8″ thick (22.5″×22.5″) panel 10 and FIG. 3 shows a system of panels 10 to be adhered to, for example, the front face of a building. Rear panel face 12 typically includes a ballistic material such as a Kevlar phenolic resin combination ½″ thick. Ceramic tiles may also be used. See U.S. Pat. No. 5,170,690 incorporation herein by this reference. Rear face 12 is typically secured to an existing structure wall using construction adhesive. Foam core 14 (e.g., 4-10″ thick low density brittle foam material) includes face 16 with hard points 18 embedded therein, typically in an array.

The foam core retains the hard points in an array (spaced, for example, 2″ on center apart from each other) and also spaces the ballistic rear face 12 and the building structure it is attached to from the hard points. The hard points may be configured as set forth in U.S. Pat. Nos. 8,011,285 and 8,464,627 incorporated herein by this reference. But note that a one piece design can be used as well as shown in FIG. 2A. The foam should be such low density so as not to trigger the RPG but yet of sufficient density to not become damaged, to retain shape, and to be sufficiently durable.

A protective coating 20 (e.g., a resin or polymer such as “Linex”) can be added to the front face and/or portions of the panel sides to protect the foam core from the elements and to render panel 10 inconspicuous, e.g., to make it appear like typical building material, siding, or the like. The protective panel can be colored, textured, and the like.

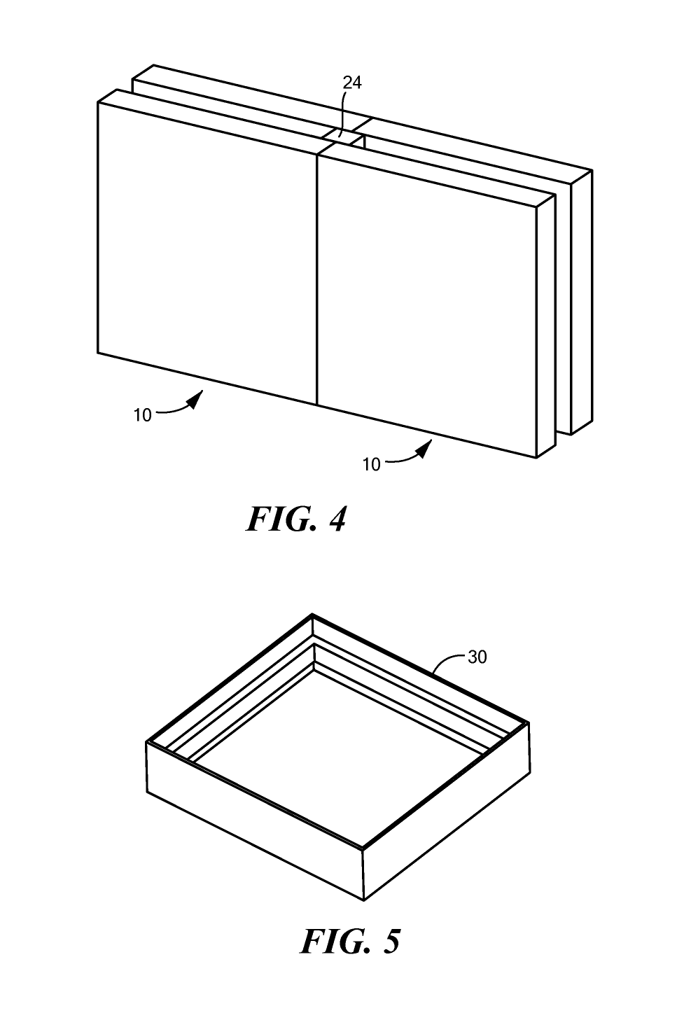

Interlocking features 22 (e.g., a recess, grove, or slot) allow two panels to be interlocked together using tongue member 24, FIGS. 3-4 which could also be made of foam and covered with a protective polymer. FIG. 4 shows two panels interlocked together via tongue member 24. Similar tongue members can be used to secure one panel on top of another and the like. Other interlocking features are possible as known to those skilled in the art in the construction trades.

TABLE 1
Table 1 further specifies an example of one test panel.

| Structure | Material | Thickness |
|---|---|---|
| Ballistic rear face | Kevlar/steel/ | 3/16″-3″ |
| | ceramic | |
| Foam core | Polyurethane, polyethylene, | 4″-10″ |
| | polystyrene | |
| Protective coating on front | Polyethylene, paint | 1/16″ or less |
| face and sides | | |

In FIG. 2B, a thin foam layer 22b is added in front of hard points 18 and behind protective layer 20 to enable the panel to have a better construction material look. This layer should include a low density material so it does not trigger the RPG piezoelectric sensor. Open cell foam 1″ thick may be used.

In general, the hard points address rocket propelled grenade type threats by duding an RPG as the sharp edges of a hard point dig into and/or through the skin of an RPG ogive shorting the fusing thereof. The foam core serves to retain the array of hard points in a spaced relationship with respect to each other and to space them from the structure or building being protected so the hard points can serve their purposes before an RPG ogive strikes the building or structure. The hard points can be press fit into and/or adhered to the foam core front face. The ballistic rear face serves to protect the building from bullets and the like. Other armor features can be incorporated into the panels such as EMI shielding or the like. Also, the panels can include channels for wiring and sensors and the like.

The protective coating and optional thin low density foam layer serve as a seal to protect the panel from the elements but yet should be thin enough and configured such that these layers do not cause the detonation of an RPG when struck by an RPG.

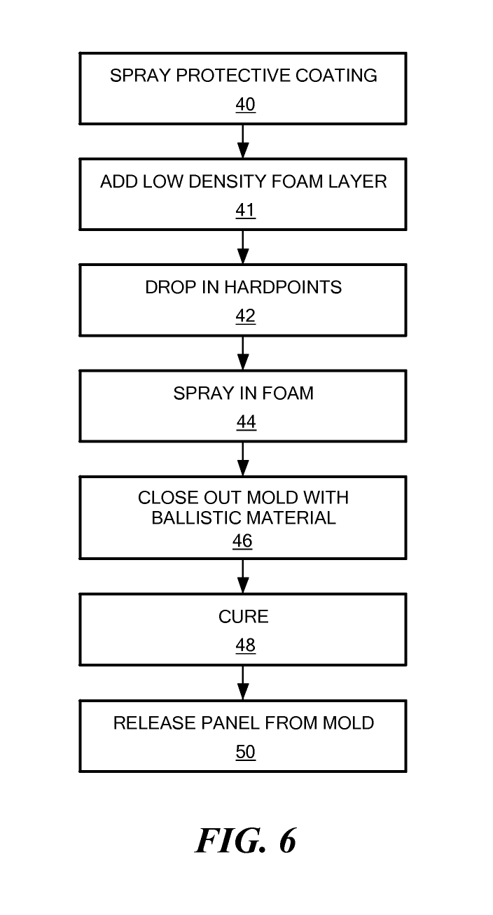

In one example, an aluminum mold 30, FIG. 5 includes a bottom and four sides but no back or top plate. The inside of the mold is sprayed with a non-stick coating and then, in step 40, FIG. 6 the inside of the mold is sprayed with the urethane material forming protective coating 20, FIG. 2A. Optionally, a low density foam layer is then placed in the mold. See FIG. 2B. Then a thin sheet (e.g., foam) preloaded with an array of hard points is dropped into the mold so the hard point outer faces face forward, step 42, FIG. 6. Next, the mold is filled with a spray in foam, step 44 and then covered with the ballistic rear face, step 46. When the sprayed in foam hardens during curing, step 48, it all locks the components in place resulting in an integrated, easily manufactured, low cost panel that can now be released from the panel, step 50.

The result is an unobtrusive system to provide protection against common threats such as bullets, fragments, and the like as well as rocket propelled grenades. The system of panels is self contained and provides protection against the most common type of threats (e.g., up to 50 caliber rounds, 20 mm FSP and various RPG types.) The panels appear to be architectural material and thus there is no indication from the outside of the purpose of the panels of the protection system.

In some examples, one or more sides of the panels can be painted or coated with an ultraviolet protective coating. Other coatings, layers, and/or strata are possible. Typically, the bottom course of panels is applied to a structure or building using construction adhesive. That course of panels is allowed to cure over night and then successive courses of panels are adhered to the building or structure on top of the previous layer.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A protective panel comprising:
a ballistic rear face;
hard points in an arrangement at or proximate a front panel face; and
a foam core retaining the arrangement of hard points and spacing the hard points from the ballistic rear face.

2. The protective panel of claim 1 further including a protective coating on the front face.

3. The protective panel of claim 1 further including a low density foam layer in front of the hard points.

4. The protective panel of claim 1 in which the ballistic rear face includes Kevlar.

5. The protective panel of claim 1 in which the ballistic rear face includes ceramic tiles.

6. The protective panel of claim 1 in which the foam core includes a low density brittle foam material.

7. The protective panel of claim 1 in which the foam core is between 4-10″ thick.

8. The protective panel of claim 1 further including an interlock feature.

9. The protective panel of claim 8 in which the interlock feature includes a recess in the sides, top, and bottom portions of the panel.

10. The protective panel of claim 1 in which the hard points are arranged in an array.

11. A protective panel comprising:
ballistic material; and
a plurality of hard points in an arrangement in a foam body spacing the hard points from each other and from the ballistic material.

12. The protective panel of claim 11 further including a protective coating on the panel.

13. The protective panel of claim 11 further including a low density foam layer in front of the hard points.

14. The protective panel of claim 11 in which the ballistic rear face includes Kevlar.

15. The protective panel of claim 11 in which the ballistic rear face includes ceramic tiles.

16. The protective panel of claim 11 in which the foam core includes a low density brittle foam material.

17. The protective panel of claim 11 in which the foam core is between 4-10″ thick.

18. The protective panel of claim 11 further including an interlock feature.

19. The protective panel of claim 18 in which the interlock feature includes a recess in the sides, top, and bottom portions of the panel.

20. The protective panel of claim 11 in which the hard points are arranged in an array.

21. A method of manufacturing a protective panel, the method comprising:
placing a structure holding an arrangement of hard points into a mold;
spraying foam into the mold; and
covering the mold with ballistic material.

22. The method of claim 21 further including the step of spraying the mold with a protective coating prior to placing the structure with the hard point arrangement therein.

23. The method of claim 21 further including placing a foam layer in the mold prior to placing the structure with the hard points arranged therein.

24. The method of claim 21 in which the ballistic material includes Kevlar.

25. The method of claim 21 in which the ballistic material includes ceramic tiles.

26. The method of claim 21 in which the foam includes a low density brittle foam material.

27. The method of claim 21 in which the foam is between 4-10″ thick.

28. The method of claim 21 further including forming an interlock feature.

29. The method of claim 28 in which the interlock feature includes a recess in the sides, top, and bottom portions of the panel.

30. The method of claim 21 in which the hard points are arranged in an array.

31. A method of protecting a building or structure, the method comprising:
attaching to the building or structure a series of panels; and
each panel including hard points in a foam material spaced from a ballistic material.
